(19) United States
(12) Patent Application Publication
(10) Pub. No.: US 2003/0209571 A1
(43) Pub. Date: Nov. 13, 2003

(54) Apparatus and method for dispensing material from a container

(76) Inventor: Charles K. Smith, Northumberland, PA (US)

Correspondence Address: William H. Eilberg, 420 Old York Road, Jenkintown, PA, 19046, US

(21) Appl. No.: 10/144,422

(22) Filed: May 13, 2002

(51) Int. Cl. G01F 11/28

(52) U.S. Cl. 222/450; 222/456; 222/548

(57) ABSTRACT

A container has a lid connected to a spout. The lid has an inner door which allows communication between the container and the spout. The spout has an outer door. To remove material from the container, one opens the inner door, while maintaining the outer door closed, and transfers material from the container to the spout. One then closes the inner door, and then opens the outer door, allowing material to exit the spout. At all times, material in the container is sealed from the outside by at least one of the inner door and the outer door. The invention helps to maintain the freshness of the material in the container, by virtually eliminating direct contact between such material and the outside environment.

### BACKGROUND OF THE INVENTION

This invention relates to the field of dispensing material from a container. The invention is particularly useful for dispensing coffee, or other material which is likely to lose its freshness after prolonged exposure to the environment.

Coffee, whether instant, freeze-dried, or freshly-ground, is typically packaged and sold in cylindrical metal cans. The cans have metal lids which are intended to be removed and replaced by flexible plastic lids. Each time the coffee is used, the lid must be removed, and the product transferred from the can to a coffee maker or other receptacle.

During the time that the lid is removed, the coffee in the can is exposed to the outside environment. This exposure causes the coffee to lose its potency, and its flavor suffers. Since a relatively large can may hold enough coffee to last for a long time, the lid is likely to be removed and replaced many times during the life of the contents of the can, especially if coffee is removed each time in small quantities. Thus, it is likely that the coffee remaining in the can will become stale, or at least less aromatic, at some time before the contents of the can have been consumed.

The present invention solves the above-described problem by providing a lid structure which substantially prevents exposure of the contents of a coffee can, or other container, to the outside environment.

### SUMMARY OF THE INVENTION

The present invention includes an apparatus for dispensing material, such as coffee, from a container. The apparatus includes a lid which can be affixed to the container, and a spout connected to the lid. The lid has an inner door which can be moved from an open position, which allows fluid communication between the interior of the container and the interior of the spout, and a closed position, which blocks fluid communication between the container and the spout. The spout also includes an outer door, allowing material to be removed from the spout. The inner and outer doors are independent and separately controlled.

In using the above-described apparatus, a spout is chosen according to the amount of material desired to be retrieved from the container, and is affixed to the container. The spout may remain permanently on the lid, or it can be removed at desired intervals. In a preferred embodiment, the apparatus may include a plurality of similar spouts, having different sizes.

After the spout is affixed, the inner door is opened, while the outer door is maintained in its closed position. The container is inverted or tilted, so as to allow material to pass from the container into the spout. The inner door is then closed. Then, the outer door is opened, and the material held within the spout is dispensed therefrom.

Throughout the above-described steps, the material is always sealed from the outside, by at least one of the inner and the outer doors. While the inner door is opened, the outer door is closed. While the outer door is open, the inner door is closed. Thus, the invention substantially eliminates exposure of the contents of the container to the outside, and helps to maintain the freshness of these contents.

The invention includes the lid and spout apparatus, as well as the combination of a container, lid, and spout. The invention also includes the method of dispensing material from a container, described above.

The present invention therefore has the primary object of providing an apparatus for dispensing material from a container.

The invention has the further object of providing an apparatus which maintains the freshness of material within a container, while the material is being stored, and while is is being dispensed.

The invention has the further object of storing and dispensing perishable, aromatic products such as coffee, while prolonging the useful life of such products.

The invention has the further object of providing a dispensing apparatus for coffee and the like, which apparatus can be used with conventional containers.

The invention has the further object of providing a method for dispensing material from a container, wherein the method virtually eliminates exposure of such material to the environment outside the container.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a cross-sectional view of the lid structure of the present invention, the lid being shown attached to a container.

FIG. 2 provides an elevational view of a set of spouts that can be used with the lid of the present invention.

FIG. 3 provides a top view of one of the spouts of FIG. 2.

FIG. 4 provides a top view of a disk which defines an inner door of the lid structure of the present invention, the inner door being shown in an open position.

FIG. 5 provides a view similar to that of FIG. 4, but showing the inner door in a closed position.

FIG. 6 provides a cross-sectional view of another embodiment of the lid structure of the present invention, wherein a cam lock holds the lid to the container.

FIG. 7 provides a detailed view of the cam lock illustrated in FIG. 6.

### DETAILED DESCRIPTION OF THE INVENTION

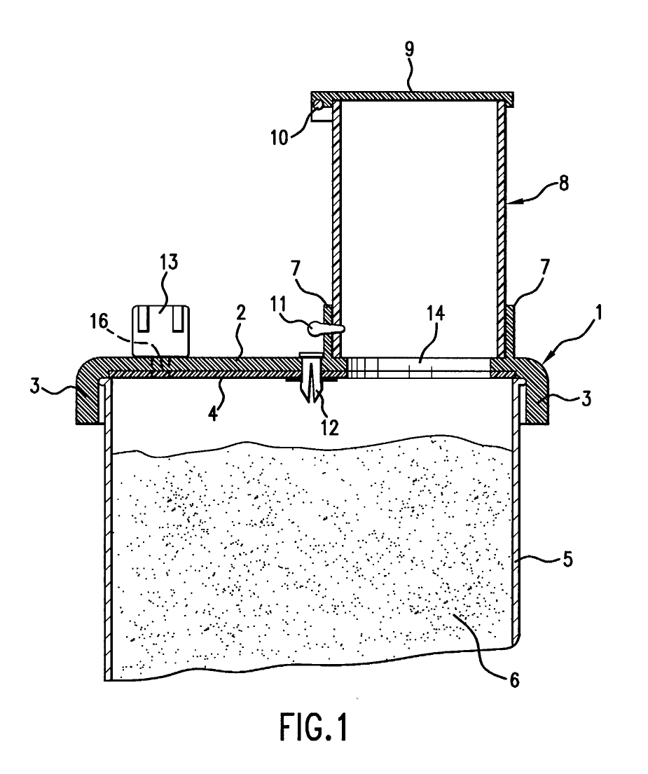

The present invention comprises an improved lid structure which fits onto a conventional coffee can, or equivalent container. FIG. 1 provides a cross-sectional view of one embodiment of the invention.

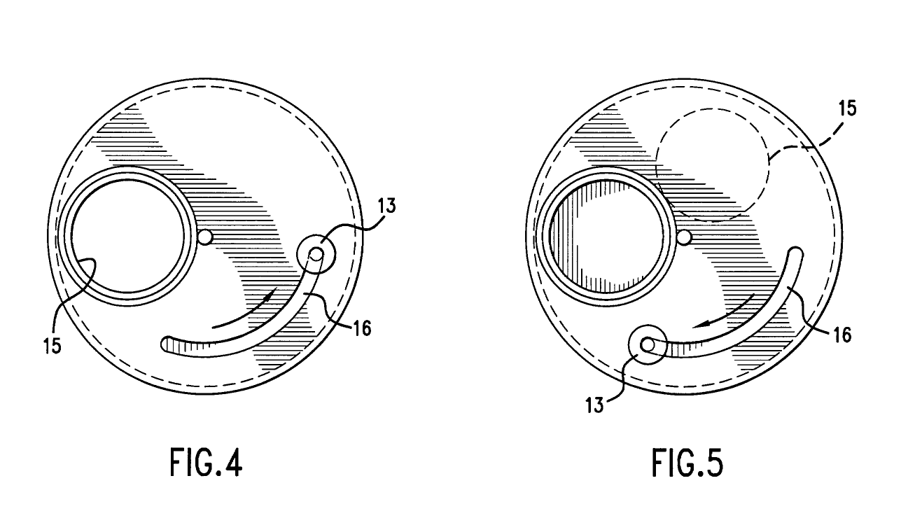

In FIG. 1, lid 1 includes flat member 2 and side flanges 3, the flat member and the side flanges being integrally formed. The lid also includes disk 4, which is shown more clearly in FIGS. 4 and 5, and which will be described in more detail with respect to those figures. The lid is shown attached to container 5, which holds material 6. The container may be a conventional coffee can, and the material may be instant, freeze-dried, or ground coffee. However, the invention is not limited to use with coffee cans, or with coffee.

The lid is preferably held to the container by friction. That is, the side flanges 3 fit snugly around the sides of the container, and thereby grip the container. Thus, the side flanges comprise one possible means for affixing the lid to the container.

Other equivalent affixation means could be used instead of the frictional grip shown in the figures. For example, the inner walls of the side flanges 3 could be threaded, and the lid could thereby be screwed onto the container (assuming that corresponding threads are provided on the container). The side flanges could also be fastened to the container by nails, or by individual screws that could be inserted through holes (not shown) in the side flanges and in the wall of the container.

The lid 1 also includes positioning flanges 7 which together define a port for attachment of spout 8. The spout is generally cylindrical, and is open at the end which is attached to the lid.

The lid also defines opening 14, which is preferably circular, and which is in registration with the open end of the spout.

The spout need not be cylindrical, but could have some other shape, as long as it can be affixed to the lid, and as long as it has an open end which can allow material to pass from the container into the spout.

The end of the spout which is not connected to the lid terminates in an outer door 9. The outer door is pivotally mounted to the spout, using pivot pin 10, so that the outer door may be opened while remaining attached to the spout, to allow the contents of the spout to be removed.

The position and size of the outer door is not limited to what is shown in the drawings, but could be varied, within the scope of the invention.

The disk 4 has a circular cutout 15 which defines an inner door which controls access between the interior of the container and the spout. FIG. 1 shows the inner door in the open position, as will be more fully explained below.

The spout is held in position, within the port defined by positioning flanges 7, by pin 11. The pin is inserted through a suitable hole in one of the positioning flanges 7, and through a hole in the side wall of the spout. Preferably, the pin extends about one-eighth inch into the interior of the spout. If the material in the container is pourable, whether it is a liquid or a pourable solid, the protrusion of the pin will have a negligible effect on the movement of material from the container into the spout.

The lid 1 and the disk 4 are held together by snap pin 12.

Knob 13 controls the rotational position of the disk, and serves as a means of opening and closing the inner door, as is more fully illustrated in FIGS. 4 and 5. The knob is connected directly to the disk. The knob can slide within arcuate slot 16. When the knob 13 is moved to the position shown in FIG. 4, the cutout 15 is aligned with opening 14, thereby allowing fluid communication between the interior of container 5 and the interior of spout 8. This is the “open” position of the inner door.

When one slides the knob, within the arcuate slot, to the opposite position, shown in FIG. 5, the disk rotates, so as to move the circular cutout 15 out of registration with the opening 14. In this position, the opening 14 is entirely blocked by the material defining the disk, the cutout 15 being positioned directly under the solid material of the lid. This is the “closed” position of the inner door. When the inner door is in the closed position, material cannot flow between the interior of the container and the interior of the spout.

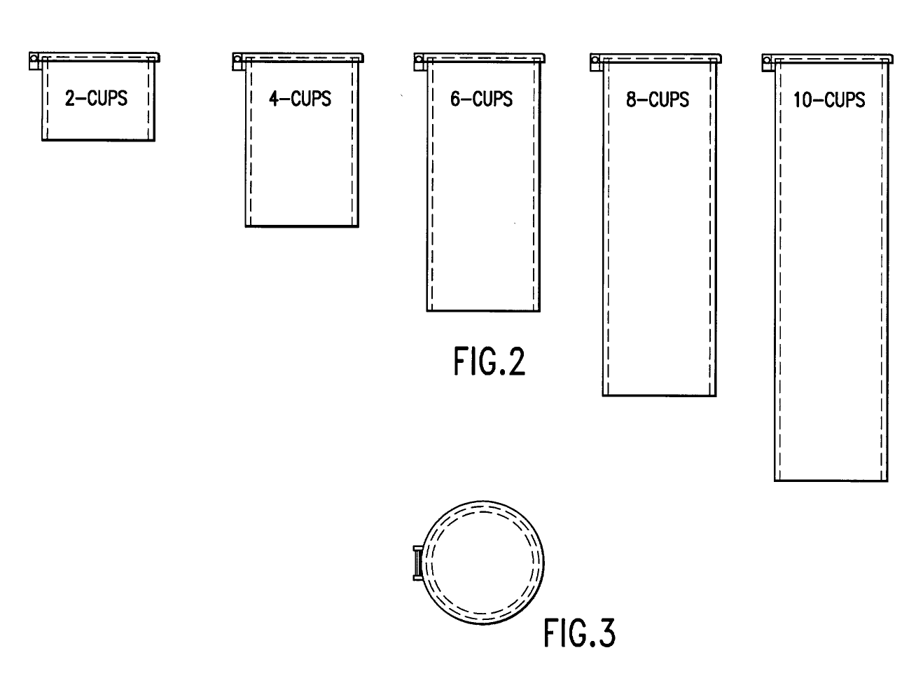

FIG. 2 shows various spouts, of differing sizes, any or all of which can be used as spout 8 of the present invention. Each spout is constructed in the same way, except that the lengths of their cylindrical walls differ, to produce spouts having varying capacities. The spouts may be labeled in various ways. In the example shown in FIG. 2, the spouts are labeled according to the number of cups of coffee that can be produced by thee contents of the spout. FIG. 3 shows the top of the spout, and is the same for all sizes.

The apparatus of FIGS. 1-5 operates in the following manner. Initially, upon purchasing the can of coffee or other material, one removes the lid that forms part of the can, and one attaches the lid of the present invention. The lid is initially provided with the inner door in the closed position, so that the contents of the can are sealed from the outside while the lid is attached. When one desires to obtain coffee or other material from the can, one selects a spout, based on desired size, as shown in FIG. 2, and inserts the spout within opening 14 and locks the spout in place using pin 11. The outer door of the spout is closed. One now opens the inner door, and inverts the can, so that coffee (or other material) flows out of the can and into the spout, by gravity. The spout becomes filled with the coffee, and the inner door is then closed. The outer door is then opened, and the coffee can be poured out into a coffee maker or other receptacle.

Throughout the above steps, it is clear that, except for a brief moment between the time that the original can lid has been removed and the lid of the present invention substituted for it, the contents of the can are always sealed from the outside. The latter statement is true because at least one of the inner and outer doors is closed at all times.

The spout may be kept attached to the lid permanently, or it may be removed after each use. Whether or not the spout is affixed to the lid, the contents of the container are still sealed from the outside, because the container is stored with the inner door in the closed position.

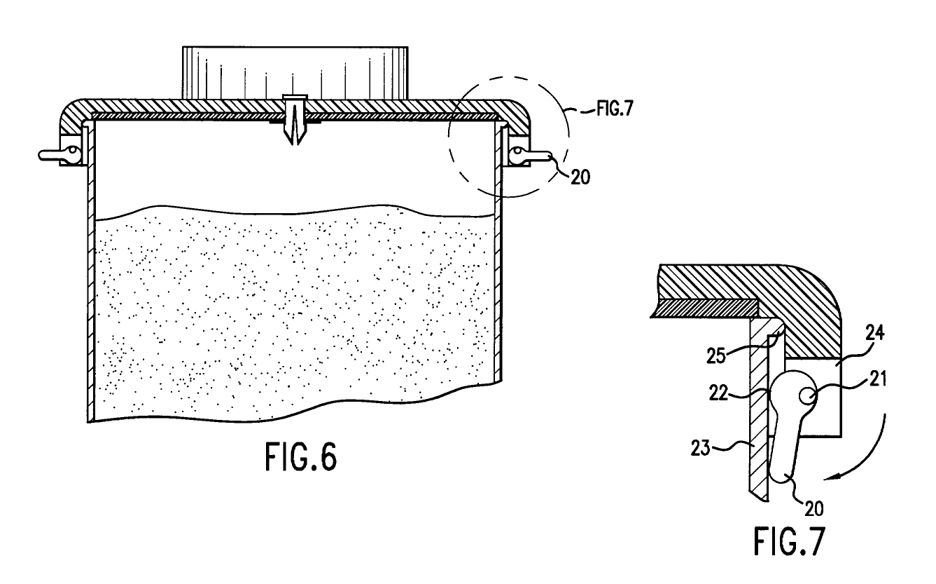

FIGS. 6 and 7 illustrate an alternative embodiment, showing another affixing means, wherein the lid is affixed to the container by a cam lock. As shown in these figures, lever 20 moves cam 22 around pivot 21. FIG. 6 shows the position in which the cam lock is not engaged, and in which the lid is released from the container. FIG. 7 shows the position in which the cam lock is engaged. The cam lock works in part by wedging the cam 22 between the wall of the container and the side flange 24 of the lid, and in part by providing a structure which will become caught on a flange 25 of the container in the event that the container is inverted. Conventional coffee cans generally are made with a flange similar to flange 25, and thus the cam lock shown in FIGS. 6 and 7 will serve to prevent the lid from coming off.

The invention can be modified in various ways. Instead of being integrally formed, the flat member 2 and the side flanges 3 could be separate pieces which are suitably joined. The container need not be a conventional coffee can, but could be some other type of container. Instead of using a pin to hold the spout in place, one could provide threads on the inner walls of positioning flanges 7, and one could therefore screw the spout into the position shown in FIG. 1. The opening 14 and the cutout 15 need not be circular, but could instead have noncircular shapes, as long as there is sufficient correspondence between these shapes that the cutout, when in full or partial registration with the opening, will allow material to flow out of the container and into the spout.

Other means of opening and closing the inner door could be provided. Instead of using aligned openings, as shown in the drawings and described above, the inner door could be a distinct door structure which is controlled by an appropriate lever mounted on the outside of the lid. What is important is that the inner and outer doors be independently operable, as it is necessary, when transferring coffee or other material, that one door be closed when the other is open.

In the embodiments described above, the means of attachment of the spout to the lid is the positioning flange and the pin 11. Other means of attachment, such as threaded attachment, or direct attachment by screws or nails, could also be used, within the scope of the invention.

The present invention is primarily intended for use in dispensing a pourable solid material, such as ground coffee, from a container. But the material being dispensed can be varied. It can be a solid or a liquid, and, if solid, can have varying degrees of coarseness, within the scope of the invention.

These and other modifications, which will be apparent to the reader skilled in the art, should be considered within the spirit and scope of the following claims.

What is claimed is:

1. Apparatus for dispensing material from a container, comprising:
a) a lid, the lid having means for affixing the lid to a container,
b) the lid including an inner door, and means for opening and closing said inner door,
c) the lid being connected to a spout, the spout having an outer door,
wherein said inner door is movable between an open position which permits material to pass through the inner door and into the spout, and a closed position which does not permit material to pass through the inner door and into the spout.

2. The apparatus of claim 1, wherein the affixing means includes a flange which is positioned to grip the container by friction.

3. The apparatus of claim 1, wherein the inner door is formed of a disk having an opening, and wherein the means for opening and closing the inner door comprises a knob for rotating the disk so as to move the opening into alignment with the spout.

4. The apparatus of claim 1, wherein the lid further comprises a positioning flange, sized to receive the spout on the lid.

5. The apparatus of claim 4, wherein the spout is locked within the positioning flange by a pin which extends through the positioning flange and at least a portion of the spout.

6. The apparatus of claim 1, wherein the affixing means comprises a cam lock.

7. Apparatus for dispensing material from a container, comprising:
a) a lid, the lid being connectable to a container,
b) the lid including an inner door which is movable between an open position and a closed position,
c) the lid being connected to a spout, the spout having an outer door,
wherein, in the open position, the inner door permits material to pass through the inner door and into the spout, and, in the closed position, the inner door does not permit material to pass through the inner door and into the spout.

8. The apparatus of claim 7, wherein the lid includes a flange which is positioned to grip the container by friction.

9. The apparatus of claim 7, wherein the inner door includes a disk having an opening, and wherein the apparatus further comprises a knob, connected to the disk, and adapted to rotate the disk so as to move the disk between the open position and the closed position.

10. The apparatus of claim 7, wherein the lid further comprises a positioning flange, sized to receive the spout on the lid.

11. The apparatus of claim 10, wherein the spout is locked within the positioning flange by a pin which extends through the positioning flange and at least a portion of the spout.

12. The apparatus of claim 7, wherein the lid includes a cam lock for affixing the lid to a container.

13. Apparatus for dispensing material comprising:
a) a container,
b) a lid attached to the container, and
c) a spout attached to the lid,
wherein the lid includes an inner door which selectively provides and blocks a connection between an interior region of the container and an interior region of the spout, and
wherein the spout includes an outer door which permits material within the spout to exit the spout.

14. The apparatus of claim 13, wherein the lid includes a flange which is positioned to grip the container by friction.

15. The apparatus of claim 13, wherein the inner door is formed of a disk having an opening, and wherein the disk is connected to a knob for rotating the disk so as to move the opening into alignment with the spout.

16. The apparatus of claim 13, wherein the lid includes a positioning flange, sized to receive the spout on the lid.

17. The apparatus of claim 16, wherein the spout is locked within the positioning flange by a pin which extends through the positioning flange and at least a portion of the spout.

18. The apparatus of claim 13, wherein the lid is affixed to the container with a cam lock.

19. A method of dispensing material from a container, the container having a lid which includes an inner door, the lid being attached to a spout which communicates with the inner door, the spout having an outer door, the method comprising:
a) opening the inner door, while maintaining the outer door in a closed position, and allowing material in the container to pass into an interior region of the spout,
b) closing the inner door, while maintaining the outer door in a closed position, so as to prevent further material from passing from the container into the spout,
c) opening the outer door, and
d) dispensing material out of the spout.

20. The method of claim 19, wherein step (a) is preceded by the step of selecting a spout of a desired size, and attaching the spout to the lid.

21. The method of claim 19, wherein step (a) includes inverting the container so as to allow material to pass into the spout by gravity.

22. The method of claim 19, wherein the inner door is opened and closed by moving a knob, connected to a disk having an opening, between an open position, wherein the opening is aligned with the spout, and a closed position, wherein the disk blocks access between the container and the spout.

23. A method of dispensing material from a container, comprising:
a) affixing a lid to a container, the container having a quantity of material, the lid having an inner door and means for attaching a spout to the lid, wherein the inner door provides access between the container and the spout,
b) selecting a spout of a desired size, and attaching the selected spout to the lid, wherein the spout includes an outer door,
c) opening the inner door, while maintaining the outer door in a closed position, and allowing material in the container to pass into an interior region of the spout,
d) closing the inner door, while maintaining the outer door in a closed position, so as to prevent further material from passing from the container into the spout,
e) opening the outer door, and
f) dispensing material from the spout.

24. The method of claim 23, wherein step (c) includes inverting the container so as to allow material to pass into the spout by gravity.

25. The method of claim 23, wherein the inner door is opened and closed by moving a knob, connected to a disk having an opening, between an open position, wherein the opening is aligned with the spout, and a closed position, wherein the disk blocks access between the container and the spout.

26. The method of claim 23, wherein step (a) comprises affixing the lid by friction.

27. The method of claim 23, wherein step (a) comprises affixing the lid by operating a cam lock.
